(19) United States
(12) Patent Application Publication
(10) Pub. No.: US 2025/0012989 A1
(43) Pub. Date: Jan. 9, 2025

(54) OPTICAL INTEGRATED DEVICE, OPTICAL TRANSMISSION DEVICE, AND OPTICAL TRANSCEIVER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/662,260

(22) Filed: May 13, 2024

(30) Foreign Application Priority Data
Jul. 7, 2023 (JP) 2023-112320

(51) Int. Cl. G02B 6/43; G02B 6/126; G02B 6/42

(52) U.S. Cl. CPC G02B 6/43; G02B 6/126; G02B 6/4202

(57) ABSTRACT

An optical integrated device includes a first chip including an optical circuit, and a second chip including an optical waveguide including a material with an electro-optic effect larger than the electro-optic effect of a material of the first chip. In the optical integrated device, the first chip is mounted in a trench formed on the second chip, and the first chip is optically coupled to the second chip by butt coupling.

### CROSS-REFERENCE TO RELATED APPLICATION

This application is based upon and claims the benefit of priority of the prior Japanese Patent Application No. 2023-112320, filed on Jul. 7, 2023, the entire contents of which are incorporated herein by reference.

### FIELD

The embodiments discussed herein are related to an optical integrated device, an optical transmission device, and an optical transceiver.

### BACKGROUND

FIG. 24 is a planar schematic view illustrating an example of an optical integrated device 100, and FIG. 25 is a schematic cross-sectional view illustrating an example of the optical integrated device 100. For convenience of explanation, the schematic cross-sectional view is a schematic cross-sectional view of the optical integrated device 100 illustrated in FIG. 24. The optical integrated device 100 has an optical modulator chip 110, a micro lens array (MLA) 121, a polarization rotator (PR) 122, a polarization beam combiner (PBC) 123, and an optical fiber array 130. The optical modulator chip 110 is, for example, a TF-LN (Thin-Film LiNbO₃) modulator chip. The optical modulator chip 110 has a optical waveguide 111 of TF-LN, a optical modulator 112 of TF-LN, an input unit 113, a first output unit 114A, and a second output unit 114B. The input unit 113, the first output unit 114A, and the second output unit 114B are located on a chip end face 110A of the optical modulator chip 110.

The optical waveguide 111 in the optical modulator chip 110 has an input waveguide 111A, a folded waveguide 111B, a first output waveguide 111C1, and a second output waveguide 111C2. The input waveguide 111A is a TF-LN waveguide extending in a straight line in a longitudinal direction of the optical modulator chip 110 from the input unit 113 of the optical modulator chip 110. The folded waveguide 111B is a TF-LN waveguide that is folded back from the input waveguide 111A and connected to an input stage of the optical modulator 112. The first output waveguide 111C1 is a TF-LN waveguide that connects an output stage of the optical modulator 112 to the first output unit 114A of the optical modulator chip 110. The second output waveguide 111C2 is a TF-LN waveguide that connects the output stage of the optical modulator 112 to the second output unit 114B of the optical modulator chip 110.

The optical modulator 112 has an optical waveguide and an electrode that applies an electrical signal to the optical waveguide, and optically modulates light passing through the optical waveguide by applying the electrical signal from the electrode. The optical fiber array 130 has an input-side optical fiber 131A that receives light and an output-side optical fiber 131B that outputs light.

The MLA 121 is an optical component that is connected to the chip end face 110A of the optical modulator chip 110 that optically couples the TF-LN optical waveguide 111 to the optical fiber array 130. The MLA 121 is connected to the input-side optical fiber 131A in the optical fiber array 130 and inputs light from the input-side optical fiber 131A into the input waveguide 111A. The MLA 121 outputs TE polarized signal light from the optical modulator 112 to the PR 122 and the PBC 123. The PR 122 rotates the polarization of signal light from the optical modulator 112 by 90° through the MLA 121, and outputs the TM polarized signal light after polarization rotation to the PBC 123. The PBC 123 polarization-multiplexes the TE polarization signal light obtained from the optical modulator 112 through the MLA 121 and the TM polarization signal light after polarization rotation, and outputs the polarization-multiplexed signal light to the output-side optical fiber 131B in the optical fiber array 130. The related technologies are described, for example, in: Japanese Laid-open Patent Publication No. 2020-134609; U.S. Patent Application Publication No. 2016/0116680; Japanese Laid-open Patent Publication No. 2020-021015; U.S. Patent Application Publication No. 2015/0355421; and Japanese Laid-open Patent Publication No. 2001-324654.

In the optical integrated device 100, by aligning the optical axes of the optical waveguide 111 on the chip end face 110A of the optical modulator chip 110 and the MLA 121, the optical modulator chip 110 and the MLA 121 are fixed with an adhesive A. Subsequently, an alignment task is needed to align the optical axes of the PR 122, the PBC 123, and the optical fiber array 130 with respect to the MLA 121.

However, since the optical waveguide 111 in the optical modulator chip 110 is a TF-LN optical waveguide with electro-optic effects, an optical mode field diameter is small, requiring a high-precision alignment task. Accordingly, the workload needed for mounting in a chip including an optical waveguide with electro-optic effects is increased.

### SUMMARY

According to an aspect of an embodiment, an optical integrated device includes a first chip including an optical circuit, and a second chip including an optical waveguide including a material with an electro-optic effect larger than the electro-optic effect of a material of the first chip. The first chip is mounted in a trench formed on the second chip, and the first chip is optically coupled to the second chip by butt coupling.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a planar schematic view illustrating an example of an optical integrated device of a first embodiment;

FIG. 2 is a schematic cross-sectional view illustrating an example of the optical integrated device;

FIG. 3 is a planar schematic view illustrating an example of an optical integrated device of a second embodiment;

FIG. 4 is a schematic cross-sectional view illustrating an example of the optical integrated device;

FIG. 5 is a planar schematic view illustrating an example of an optical integrated device of a third embodiment;

FIG. 6 is a schematic cross-sectional view illustrating an example of the optical integrated device;

FIG. 7 is a planar schematic view illustrating an example of an optical integrated device of a fourth embodiment;

FIG. 8 is a schematic cross-sectional view illustrating an example of the optical integrated device;

FIG. 9 is a planar schematic view illustrating an example of an optical integrated device of a fifth embodiment;

FIG. 10 is a schematic cross-sectional view illustrating an example of the optical integrated device;

FIG. 11 is a planar schematic view illustrating an example of an optical integrated device of a sixth embodiment;

FIG. 12 is a schematic cross-sectional view illustrating an example of the optical integrated device;

FIG. 13 is a planar schematic view illustrating an example of an optical integrated device of a seventh embodiment;

FIG. 14 is a schematic cross-sectional view illustrating an example of the optical integrated device;

FIG. 15 is a planar schematic view illustrating an example of an optical integrated device of an eighth embodiment;

FIG. 16 is a schematic cross-sectional view illustrating an example of the optical integrated device;

FIG. 17 is a planar schematic view illustrating an example of an optical integrated device of a ninth embodiment;

FIG. 18 is a schematic cross-sectional view illustrating an example of the optical integrated device;

FIG. 19 is a planar schematic view illustrating an example of an optical integrated device of a tenth embodiment;

FIG. 20 is a schematic cross-sectional view illustrating an example of the optical integrated device;

FIG. 21 is a planar schematic view illustrating an example of an optical integrated device of an eleventh embodiment;

FIG. 22 is a schematic cross-sectional view illustrating an example of the optical integrated device;

FIG. 23 is an explanation diagram illustrating an example of an optical transceiver of the present example;

FIG. 24 is a planar schematic view illustrating an example of an optical integrated device; and

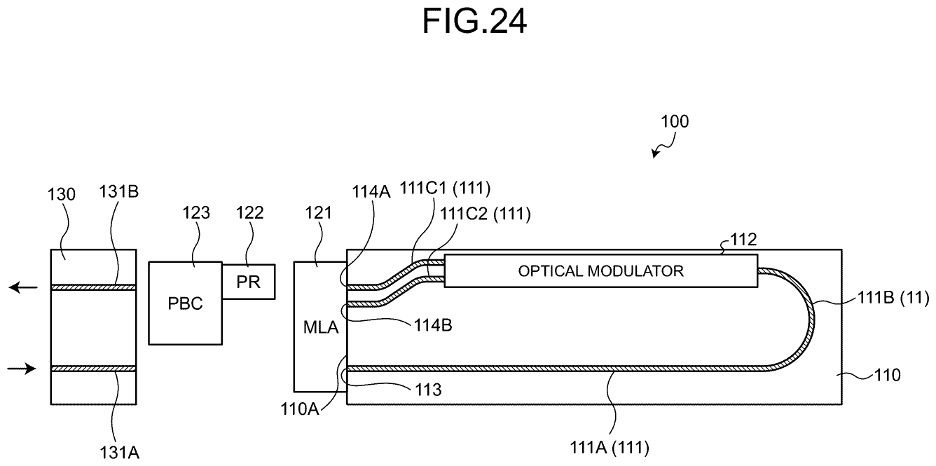

FIG. 25 is a schematic cross-sectional view illustrating an example of the optical integrated device.

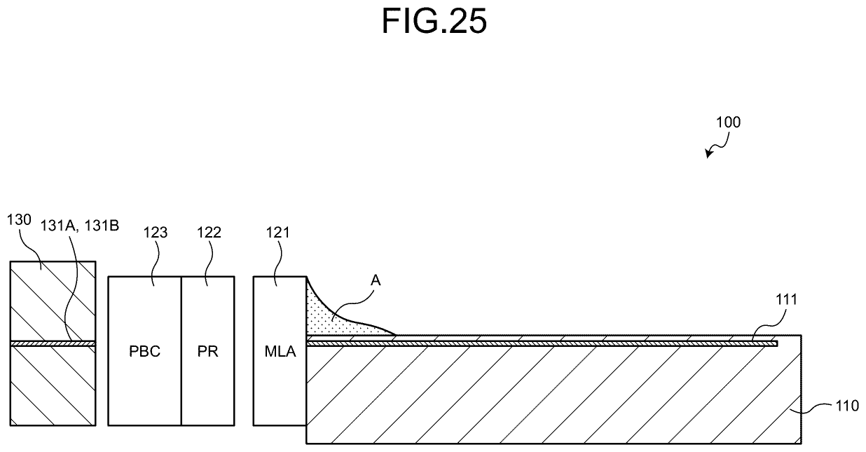

### DESCRIPTION OF EMBODIMENTS

Preferred embodiments of the present invention will be explained with reference to accompanying drawings. The present example does not limit the disclosed technology. Each of the examples illustrated below may be combined as appropriate to the extent that it causes no inconsistency.

### (a) First Embodiment

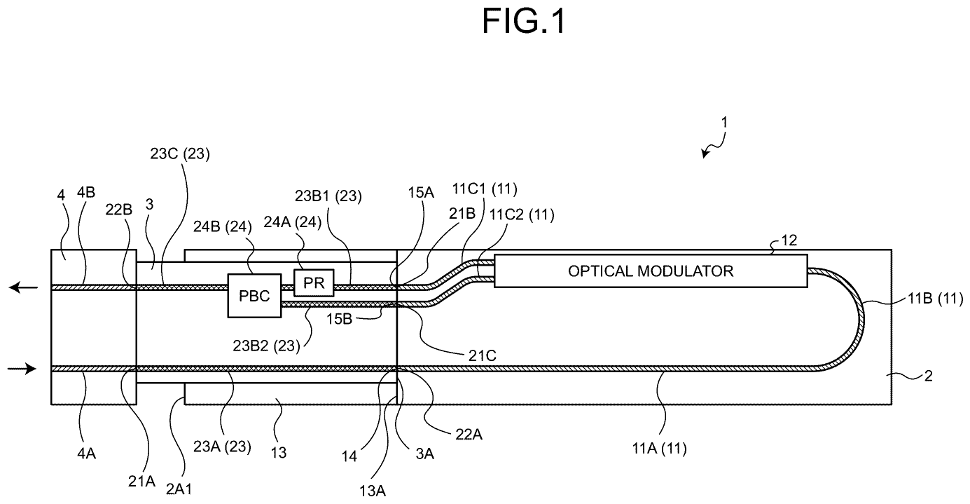

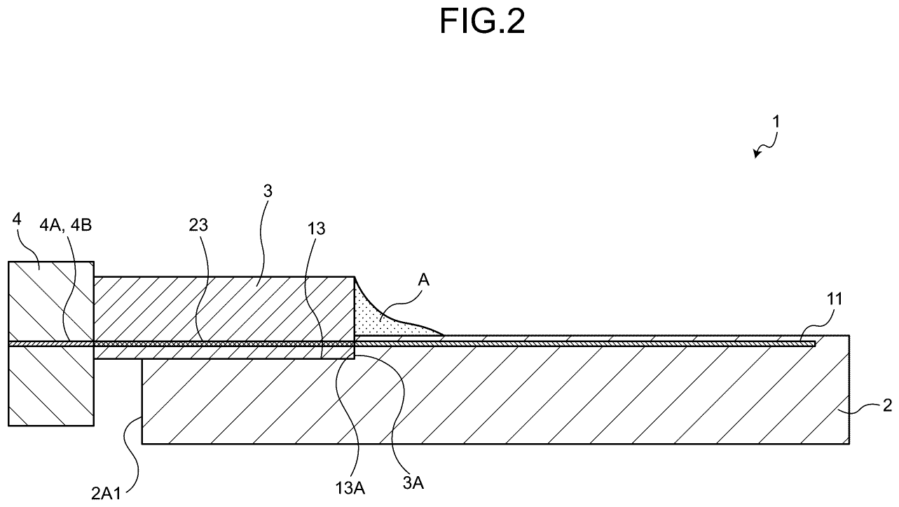

FIG. 1 is a planar schematic view illustrating an example of an optical integrated device 1 of a first embodiment, and FIG. 2 is a schematic cross-sectional view illustrating an example of the optical integrated device 1. For convenience of explanation, the schematic cross-sectional view is a schematic cross-sectional view of the optical integrated device 1. The optical integrated device 1 has a second chip 2 including a second optical waveguide 11 with electro-optic effects, a first chip 3 including an optical circuit 24 and a first optical waveguide 23, and an optical fiber array 4. The second chip 2 is, for example, a chip with electro-optic effects, such as TF-LN (Thin-Film LiNbO₃). The second chip 2 is a thin-film substrate of LN with a submicron thickness. The first chip 3 is, for example, a silicon photonics (SiPh) chip. The optical fiber array 4 has an input-side optical fiber 4A that receives light and an output-side optical fiber 4B that outputs light.

The second chip 2 has the second optical waveguide 11 made of TF-LN material, an optical modulator 12 made of TF-LN material, a trench 13 formed on a chip end face 2A1, an input unit 14, a first output unit 15A, and a second output unit 15B. The trench 13 is formed on the chip end face 2A1 of the second chip 2 and serves as a terrace structure for mounting the first chip 3. The input unit 14 is a part that is located on a second bonding surface 13A of the trench 13 and receives light from the first optical waveguide 23 of the first chip 3. The second bonding surface 13A is a surface that is in contact with a first bonding surface 3A of the first chip 3 to be described below. The first output unit 15A and the second output unit 15B are parts that are located on the second bonding surface 13A of the trench 13 and output signal light from the optical modulator 12 to the first optical waveguide 23 of the first chip 3.

The second optical waveguide 11 has an input waveguide 11A, a folded waveguide 11B, a first output waveguide 11C1, and a second output waveguide 11C2. The input waveguide 11A is a linear TF-LN optical waveguide extending from the input unit 14 in a longitudinal direction of the second chip 2 and is connected to the folded waveguide 11B. The folded waveguide 11B is a folded TF-LN waveguide that connects the input waveguide 11A to an input stage of optical modulator 12. The first output waveguide 11C1 is a TF-LN waveguide that connects an output stage of the optical modulator 12 to the first output unit 15A. The second output waveguide 11C2 is a TF-LN waveguide that connects the output stage of the optical modulator 12 to the second output unit 15B.

The first chip 3 has a first input unit 21A, a second input unit 21B, a third input unit 21C, a first output unit 22A, a second output unit 22B, a first optical waveguide 23, and an optical circuit 24. The optical circuit 24 has a polarization rotator (PR) 24A made of Si material, and a polarization beam combiner (PBC) 24B made of Si material. The first input unit 21A is a part that is located on a surface that is connected to the optical fiber array 4, and receives light from an input-side optical fiber 4A in the optical fiber array 4. The first output unit 22A is a part that is located on the first bonding surface 3A that is in contact with the second bonding surface 13A of the second chip 2, and outputs light from the first input unit 21A to the second chip 2. The second input unit 21B is a part that is located on the first bonding surface 3A, and inputs light from the optical modulator 12 in the second chip 2 to the PR 24A. The third input unit 21C is a part that is located on the first bonding surface 3A, and inputs light from the optical modulator 12 in the second chip 2 to the PBC 24B. The second output unit 22B is a part that is located on a surface that is connected to the optical fiber array 4, and outputs signal light from the PBC 24B to the output-side optical fiber 4B in the optical fiber array 4.

The first optical waveguide 23 has an input waveguide 23A, a first input waveguide 23B1, a second input waveguide 23B2, and an output waveguide 23C. The input waveguide 23A is a Si waveguide that connects the first input unit 21A to the first output unit 22A. The first input waveguide 23B1 is a Si waveguide that connects the second input unit 21B to the PR 24A. The second input waveguide 23B2 is a Si waveguide that connects the third input unit 21C to the PBC 24B. The output waveguide 23C is a Si waveguide that connects the second output unit 22B to the PBC 24B.

The PR 24A is a polarization rotation unit that converts TE-polarized signal light from the first input waveguide 23B1 into TM-polarized signal light by rotating the polarization of the TE-polarized signal light by 90°, and outputs the TM-polarized signal light to the PBC 24B. The PBC 24B is a polarization multiplexer that polarization-multiplexes TE-polarized signal light from the second input waveguide 23B2 and the TM-polarized signal light after polarization rotation from the PR 24A, and outputs the polarization-multiplexed signal light to the output waveguide 23C.

A portion near the chip end face 2A1 of the second chip 2 is provided with the trench 13 having a terrace structure for mounting the first chip 3, for example, face-down. The trench 13 is formed by etching the surface of the second chip 2, for example. On the second bonding surface 13A serving as a wall surface of the trench 13, the first output unit 22A, the first input unit 21A, and the second input unit 21B are located as described above.

For face-down mounting of the first chip 3 in the trench 13 of the second chip 2, the second optical waveguide 11 of the second chip 2 and the first optical waveguide 23 of the first chip 3 are optically coupled by butt coupling using an adhesive A. As a result, the input unit 14 in the second chip 2 and the first output unit 22A in the first chip 3 are optically connected. Moreover, the first output unit 15A in the second chip 2 and the second input unit 21B in the first chip 3 are optically connected, and the second output unit 15B in the second chip 2 and the third input unit 21C in the first chip 3 are optically connected.

Moreover, the first chip 3 is connected to the optical fiber array 4 with the adhesive A, so that the first input unit 21A and the input-side optical fiber 4A are optically connected and the second output unit 22B and the output-side optical fiber 4B are optically connected.

In the optical integrated device 1 of the first embodiment, the first chip 3 including the optical circuit 24 is mounted on the trench 13 in the second chip 2 with electro-optic effects, and the second optical waveguide 11 of the second chip 2 and the first optical waveguide 23 of the first chip 3 are optically coupled by butt coupling. As a result, since components of the PR 24A and the PBC 24B need not to be individually mounted, the number of components can be reduced and the workload needed for mounting in the second chip 2 with electro-optic effects can be significantly reduced.

In general, an LN modulator chip is larger in size than a SiPh chip, and when the LN modulator is mounted by forming a trench on the SiPh chip, the size of the SiPh chip also needs to be increased to match the size of the LN modulator. On the other hand, since the optical integrated device 1 of the first embodiment does not need to match the size of the first chip 3 being a SiPh chip with the second chip 2 being an LN modulator chip, waste of the first chip 3 can be eliminated.

Since the first chip 3 is mounted face-down on the trench 13 in the second chip 2, the depth of the trench 13 formed on the second chip 2 can be made shallow. Accordingly, the burden needed for etching when the trench 13 is formed can be reduced.

Since the optical modulator 12 of the second chip 2 is a TF-LN crystal optical modulator, the drive voltage of the modulator can be reduced by allowing a large electro-optic effect.

Since the first chip 3 is a SiPh chip, the optical circuit 24 including the PR 24A and the PBC 24B can be made smaller.

For convenience of explanation, the case of face-down mounting of the first chip 3 on the trench 13 of the second chip 2 is illustrated as an example, but face-up mounting may also be used and the mounting method can be modified as needed. In the first chip 3, since the first optical waveguide 23 is formed near the chip surface, the first chip 3 can be mounted face up on the trench 13 of the second chip 2 by increasing the depth of the trench 13.

Although the TF-LN is illustrated as an example of the material for the electro-optic effect, the material is not limited to TF-LN. For example, the material may be TF-Barium Titanate and can be modified as needed. The material for the electro-optic effect may be, for example, TF-BTO (BaTiO₃), TF-PLZT (PbLaZrTiO₃), and TF-PZT (PbZrTiO₃).

In the optical integrated device 1 of the first embodiment, the case of optical coupling between the second optical waveguide 11 in the second chip 2 and the first optical waveguide 23 in the first chip 3 by butt coupling is illustrated as an example. However, when a spacing X between the input waveguide 11A and the first output waveguide 11C1 within the second optical waveguide 11 in the second chip 2 becomes wider, the optical axis misalignment becomes larger when the placement angle of the first chip 3 is deviated at the time of mounting of the first chip 3 to the second chip 2. As a result, the coupling loss between the second optical waveguide 11 and the first optical waveguide 23 is increased. In this regard, an embodiment that addresses such a situation is described below as a second embodiment.

### (b) Second Embodiment

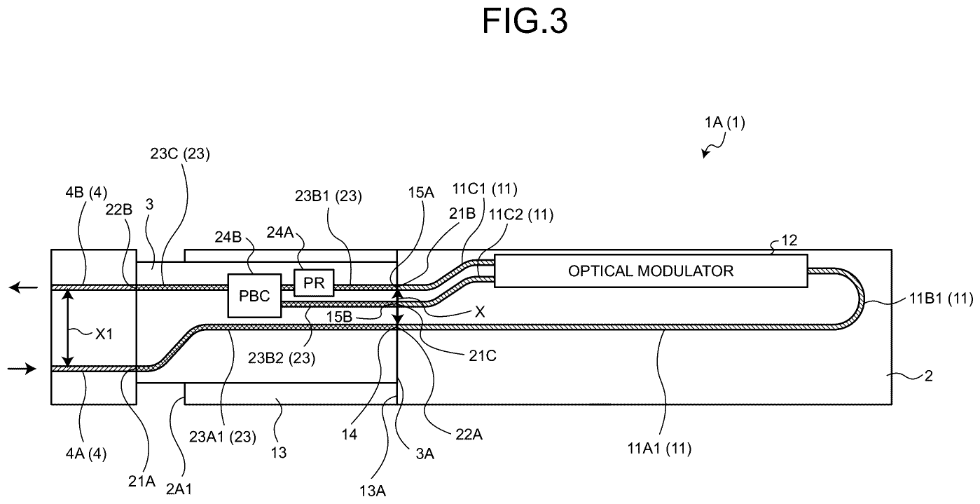

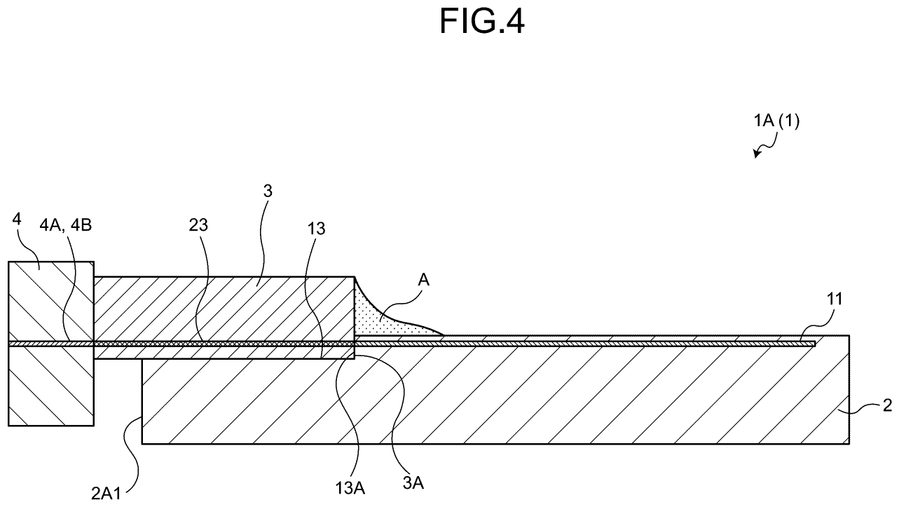

FIG. 3 is a planar schematic view illustrating an example of an optical integrated device 1A of the second embodiment, and FIG. 4 is a schematic cross-sectional view illustrating an example of the optical integrated device 1A. The same symbols are attached to the same configurations as those of the optical integrated device 1 in the first embodiment, and descriptions of duplicated configurations and operations are omitted. A spacing X between an input waveguide 11A1 and the first output waveguide 11C1 at a butt coupling point of the second chip 2 and a spacing X between an input waveguide 23A1 and the first input waveguide 23B1 at a butt coupling point of the first chip 3 are narrower. The butt coupling point is a part where the second chip 2 and the first chip 3 are optically coupled by butt coupling. The spacing X between the input waveguide 11A1 and the first output waveguide 11C1 and the spacing X between the input waveguide 23A1 and the first input waveguide 23B1 are narrower than a spacing X1 between the input-side optical fiber 4A and the output-side optical fiber 4B.

For face-down mounting of the first chip 3 in the trench 13 of the second chip 2, the second optical waveguide 11 of the second chip 2 and the first optical waveguide 23 of the first chip 3 are optically coupled by butt coupling using the adhesive A. That is, the input waveguide 11A1 of the input unit 14 in the second chip 2 and the input waveguide 23A of the first output unit 22A in the first chip 3 are optically connected. The first output waveguide 11C1 of the first output unit 15A in the second chip 2 and the first input waveguide 23B1 of the second input unit 21B in the first chip 3 are optically connected. Moreover, the second output waveguide 11C2 of the second output unit 15B in the second chip 2 and the second input waveguide 23B2 of the third input unit 21C in the first chip 3 are optically connected.

Since the spacing X between the input waveguide 11A1 and the first output waveguide 11C1 of the second chip 2 is narrower, the radius of curvature of a folded waveguide 11B1 is smaller than the radius of curvature of the folded waveguide 11B illustrated in FIG. 1.

The input waveguide 23A1 in the first chip 3 is curved to align a spacing between the input waveguide 23A1 and the output waveguide 23C in the first chip 3 with the spacing X1 between the input-side optical fiber 4A and the output-side optical fiber 4B of the optical fiber array 4.

In the optical integrated device 1A of the second embodiment, the spacing X between the input waveguide 11A1 and the first output waveguide 11C1 at the butt coupling point of the second chip 2 is narrower than the spacing X1 between the input-side optical fiber 4A and the output-side optical fiber 4B of the optical fiber array 4. As a result, a tolerance due to the deviation in the placement angle of the first chip 3 at the time of mounting of the first chip 3 can be loosened, and the deterioration of a coupling loss between the second optical waveguide 11 and the first optical waveguide 23 can be suppressed.

In the optical integrated device 1A of the second embodiment, since the spacing X between the input waveguide 11A1 and the first output waveguide 11C1 of the second chip 2 is narrower, the radius of curvature of the folded waveguide 11B1 is smaller. As a result, a radiation loss may occur in the folded waveguide 11B1. In this regard, an embodiment that addresses such a situation is described below as a third embodiment.

### (c) Third Embodiment

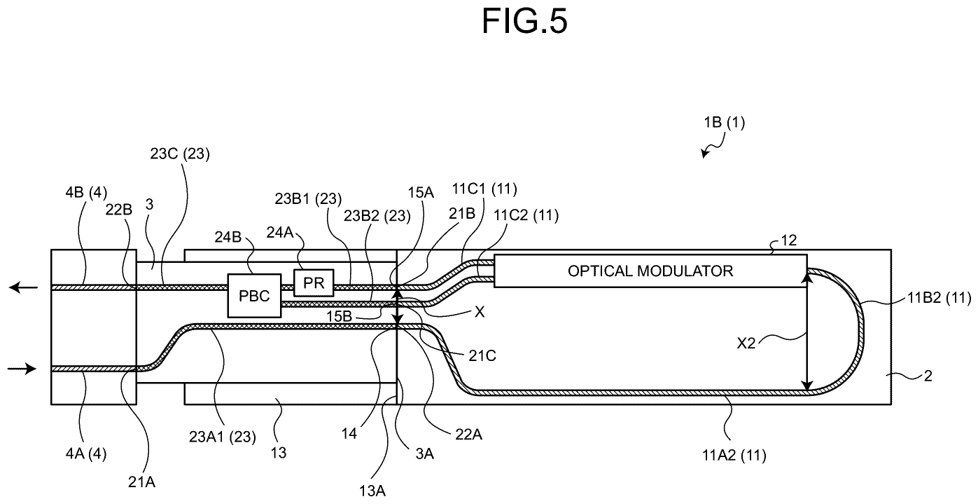

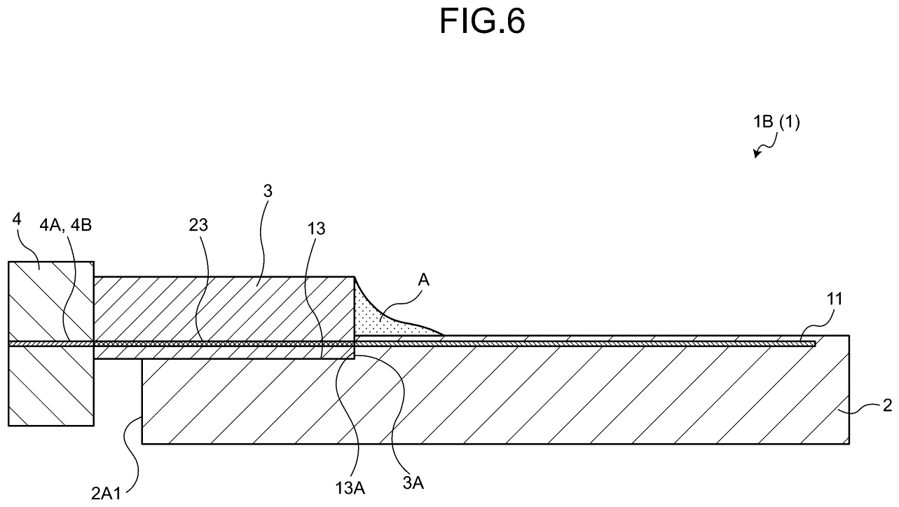

FIG. 5 is a planar schematic view illustrating an example of an optical integrated device 1B of the third embodiment, and FIG. 6 is a schematic cross-sectional view illustrating an example of the optical integrated device 1B. The same symbols are attached to the same configurations as those of the optical integrated device 1A in the second embodiment, and descriptions of duplicated configurations and operations are omitted. The diameter of a folded waveguide 11B2 in the second chip 2 is wider than a spacing X between an input waveguide 11A2 and the first output waveguide 11C1 at the butt coupling point in the second chip 2.

A diameter X2 of the folded waveguide 11B2 in the second chip 2 in the optical integrated device 1B of the third embodiment is wider than the spacing X between the input waveguide 11A2 and the first output waveguide 11C1 at the butt coupling point in the second chip 2. As a result, since the radius of curvature of the folded waveguide 11B2 is increased, a radiation loss in the folded waveguide 11B2 can be suppressed.

In the optical integrated device 1B of the third embodiment, an alignment task for aligning the optical axes of the second optical waveguide 11 and the first optical waveguide 23 of the TF-LN, which has a small optical mode field diameter, needs high precision, resulting in an increase in the workload for mounting. In this regard, an embodiment that addresses such a situation is described below as a fourth embodiment.

### (d) Fourth Embodiment

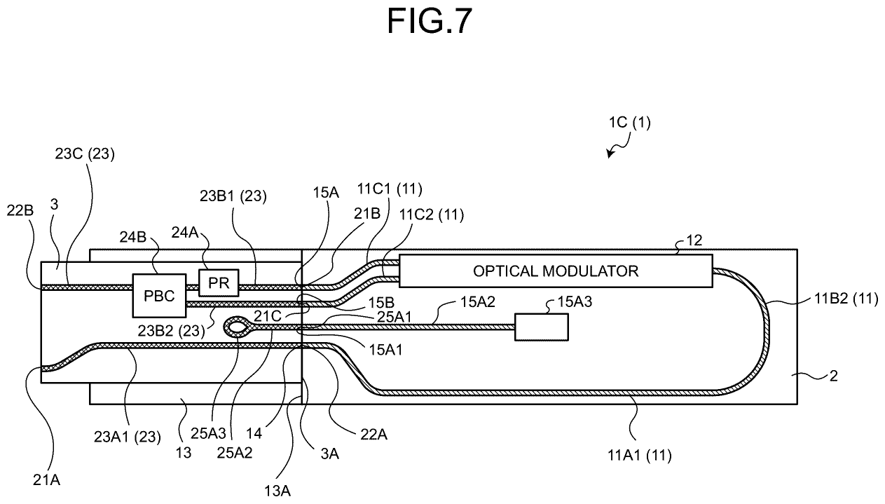

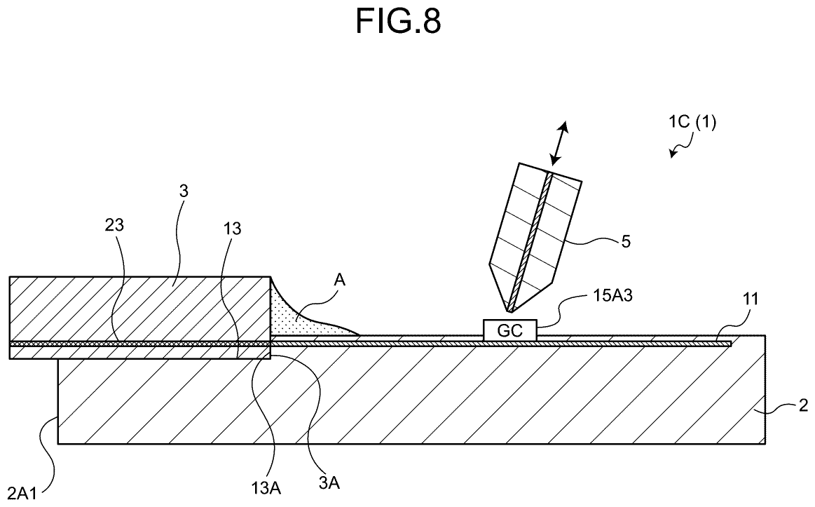

FIG. 7 is a planar schematic view illustrating an example of an optical integrated device 1C of the fourth embodiment, and FIG. 8 is a schematic cross-sectional view illustrating an example of the optical integrated device 1C. The same symbols are attached to the same configurations as those of the optical integrated device 1B in the third embodiment, and descriptions of duplicated configurations and operations are omitted. The second chip 2 has a test output unit 15A1, a test waveguide 15A2 that is connected to the test output unit 15A1, and a grating coupler (GC) 15A3 that is connected to the test waveguide 15A2 and is also connected to an optical fiber 5 that outputs test light. The test output unit 15A1 is located between the input unit 14 and the second output unit 15B on the second bonding surface 13A in the trench 13. The test waveguide 15A2 is a TF-LN waveguide that is located between the input waveguide 11A1 of the input unit 14 and the second output waveguide 11C2 of the second output unit 15B, and is connected to the test output unit 15A1. The GC 15A3 is a coupler that connects the test waveguide 15A2 to the optical fiber 5.

The first chip 3 has a test input unit 25A1, a test waveguide 25A2 that is connected to the test input unit 25A1, and a loop mirror 25A3 that is connected to the test waveguide 25A2. The test input unit 25A1 is located between the first output unit 22A and the third input unit 21C on the first bonding surface 3A of the first chip 3, and is connected to the test output unit 15A1 of the second chip 2. The test waveguide 25A2 is a Si waveguide that is located between the input waveguide 23A1 of the first output unit 22A and the second input waveguide 23B2 of the third input unit 21C, and is connected to the test input unit 25A1. The loop mirror 25A3 is a mirror that is connected to the test waveguide 25A2 and reflects the test light input from the test waveguide 25A2.

When the first chip 3 is mounted in the trench 13 of the second chip 2, the test output unit 15A1 in the second chip 2 is connected to the test input unit 25A1 in the first chip 3. The GC 15A3 outputs the test light from the optical fiber 5 from the test waveguide 15A2 in the second chip 2 to the test waveguide 25A2 in the first chip 3 through the test input unit 25A1. Moreover, the loop mirror 25A3 reflects the test light, which is input from the test waveguide 25A2, to the test waveguide 25A2, and outputs the reflected test light to the test waveguide 15A2. Subsequently, the GC 15A3 outputs the reflected test light from the test waveguide 15A2 to a test monitor (not illustrated). The test monitor receives the reflected test light. On the basis of the power of the reflected light, the test monitor can reliably perform an alignment task of aligning the optical axes of the second optical waveguide 11 of the second chip 2 and the first optical waveguide 23 of the first chip 3.

In the optical integrated device 1C of the fourth embodiment, the GC 15A3 in the second chip 2 and the loop mirror 25A3 in the first chip 3 are optically connected with the test waveguides 15A2 and 25A2. Moreover, the optical integrated device 1C can implement an alignment task of aligning the optical axes of the second optical waveguide 11 in the second chip 2 and the first optical waveguide 23 in the first chip 3 on the basis of the power of the reflected light of the loop mirror 25A3 to the test light input from the GC 15A3. As a result, the workload for optical coupling between the second optical waveguide 11 and the first optical waveguide 23 can be reduced.

The test monitor connected to the GC 15A3 monitors the power of the reflected light, and when the power of the reflected light is at a predetermined level, the optical axes of the second optical waveguide 11 in the second chip 2 and the first optical waveguide 23 in the first chip 3 can be determined to be aligned. When the power of the reflected light is less than a predetermined level, the test monitor can determine that the optical axes of the second optical waveguide 11 and the first optical waveguide 23 are not aligned.

Since a path from the GC 15A3 to the loop mirror 25A3 is independent of a path for inputting and outputting light to/from the optical modulator 12, the influence on the performance of the modulator due to test light and reflected light used by the GC 15A3 and the loop mirror 25A3, which are provided for a mounting task, can be suppressed.

In the optical integrated device 1C, when the GC 15A3 and the optical fiber 5 are not aligned, it is not possible to accurately determine whether the test waveguide 15A2 in the second chip 2 and the test waveguide 25A2 in the first chip 3 are aligned. In this regard, an embodiment that addresses such a situation is described below as a fifth embodiment.

### (e) Fifth Embodiment

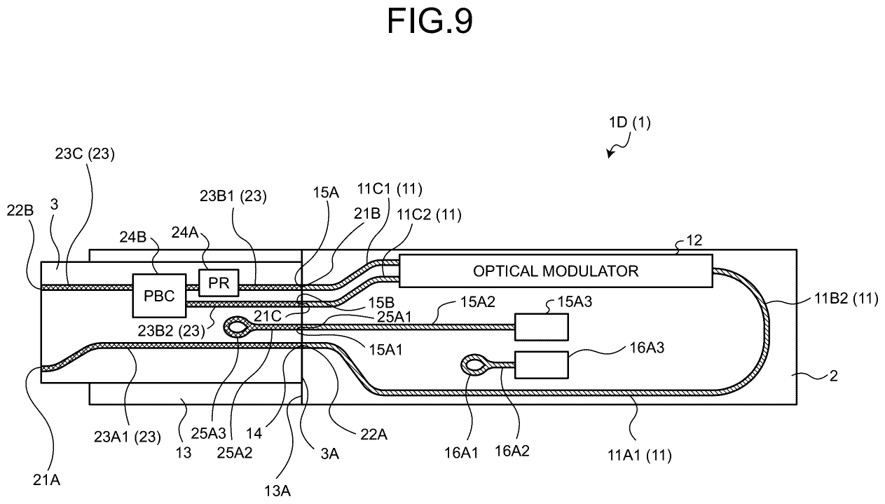

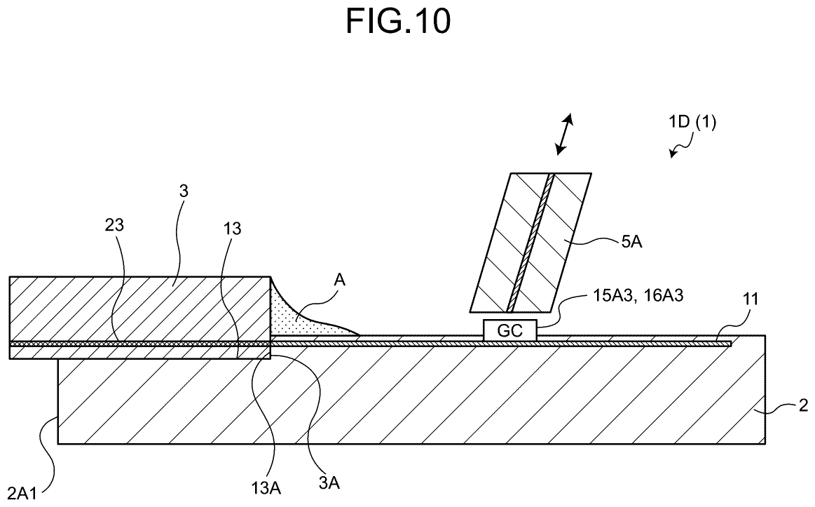

FIG. 9 is a planar schematic view illustrating an example of an optical integrated device 1D of the fifth embodiment, and FIG. 10 is a schematic cross-sectional view illustrating an example of the optical integrated device 1D. The same symbols are attached to the same configurations as those of the optical integrated device 1C in the fourth embodiment, and descriptions of duplicated configurations and operations are omitted. The second chip 2 has a first GC 16A3, a first test waveguide 16A2, and a first loop mirror 16A1, in addition to the test output unit 15A1, the test waveguide 15A2, and the GC 15A3.

The GC 15A3 is connected to a first optical fiber in a two-core fiber array 5A, is also connected to the test waveguide 15A2, and outputs first test light from the first optical fiber to the test waveguide 15A2. The GC 15A3 outputs, to the test monitor, first reflected light for the first test light from the test waveguide 15A2. The test output unit 15A1 of the test waveguide 15A2 is connected to the test input unit 25A1 of the first chip 3, outputs the first test light from the GC 15A3, and outputs, to the test waveguide 15A2, the first reflected light for the first test light from the test input unit 25A1. Subsequently, the test monitor connected to the GC 15A3 receives the first reflected light.

The first GC 16A3 is connected to a second optical fiber in the two-core fiber array 5A, is also connected to the first test waveguide 16A2, and outputs second test light from the second optical fiber to the first test waveguide 16A2. The first GC 16A3 outputs, to the test monitor, second reflected light for the second test light from the first test waveguide 16A2. The first test waveguide 16A2 is a TF-LN optical waveguide that connects the first GC 16A3 to the first loop mirror 16A1. The first loop mirror 16A1 receives the second test light from the first test waveguide 16A2, and reflects the second test light to the first test waveguide 16A2 as the second reflected light for the second test light. Subsequently, the test monitor connected to the first GC 16A3 receives the second reflected light.

The first GC 16A3 is connected to the second optical fiber in the two-core fiber array 5A, and outputs, to the first test waveguide 16A2, the second test light from the second optical fiber. The first loop mirror 16A1 outputs the second test light from the first test waveguide 16A2 as the second reflected light to the first test waveguide 16A2. Subsequently, the test monitor connected to the first GC 16A3 receives the second reflected light from the first test waveguide 16A2. On the basis of the power of the second reflected light, the test monitor checks the alignment placement between the first GC 16A3 in the second chip 2 and the second optical fiber. When the power of the second reflected light is above a predetermined level, the test monitor determines that the GC 15A3 in the second chip 2 and the second optical fiber are aligned, that is, the second chip 2 and the two-core fiber array 5A are aligned.

After it is determined that the second chip 2 and the two-core fiber array 5A are aligned, the GC 15A3 outputs, to the test waveguide 15A2, the first test light from the first optical fiber in the two-core fiber array 5A. The loop mirror 25A3 outputs, to the test waveguide 15A2, the first reflected light for the first test light from the test waveguide 15A2. Subsequently, the test monitor connected to the GC 15A3 receives the first reflected light from the test waveguide 15A2. On the basis of the power of the first reflected light, the test monitor can accurately determine whether the second optical waveguide 11 in the second chip 2 and the first optical waveguide 23 in the first chip 3 are aligned.

In the optical integrated device 1D, the case in which the test waveguide 25A2 connected to the single loop mirror 25A3 in the first chip 3 is connected to the test waveguide 15A2 in the second chip 2 is illustrated as an example. However, the embodiment is not limited to the case in which the single loop mirror 25A3 exists in the first chip 3, and a plurality of loop mirrors may be used, which is described below as a sixth embodiment.

### (f) Sixth Embodiment

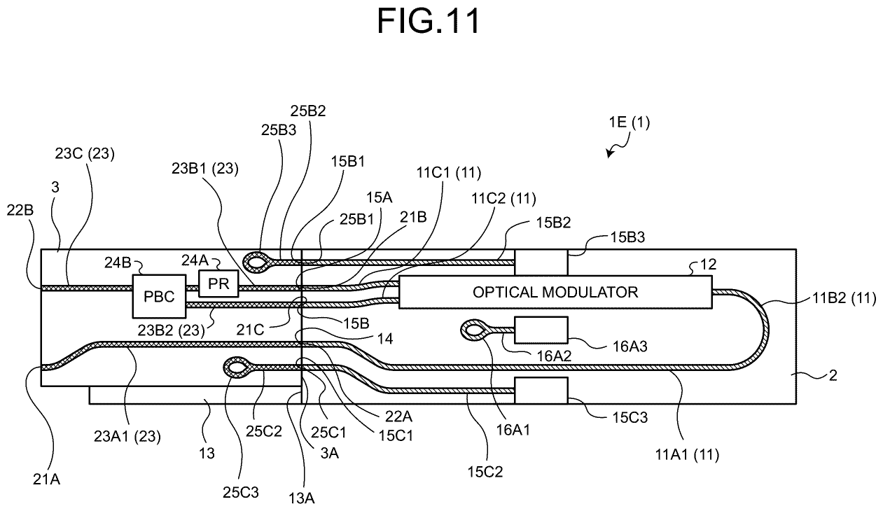

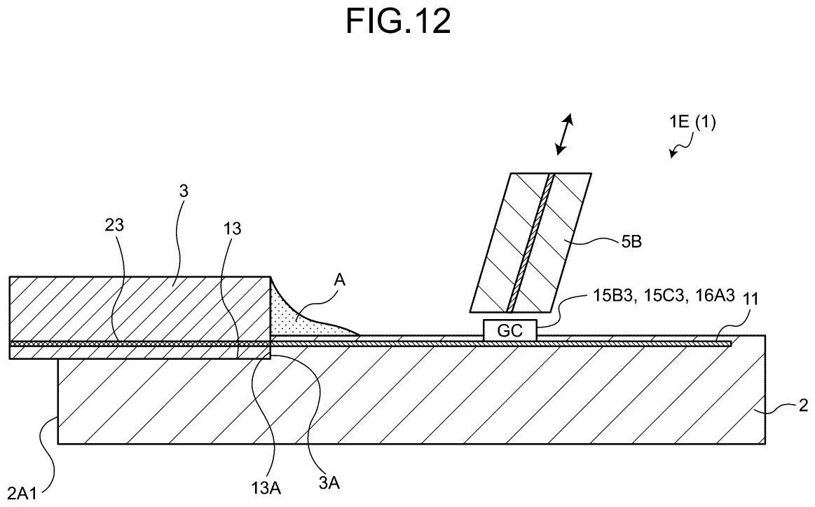

FIG. 11 is a planar schematic view illustrating an example of an optical integrated device 1E of the sixth embodiment, and FIG. 12 is a schematic cross-sectional view illustrating an example of the optical integrated device 1E. The same symbols are attached to the same configurations as those of the optical integrated device 1D in the fifth embodiment, and descriptions of duplicated configurations and operations are omitted. The difference between the optical integrated device 1E and the optical integrated device 1D is that a plurality of loop mirrors, for example, two loop mirrors, are located in the first chip 3.

The second chip 2 has a third GC 15B3, a third test waveguide 15B2, and a third test output unit 15B1 that are located outside the optical modulator 12. Moreover, the second chip 2 has a fourth GC 15C3, a fourth test waveguide 15C2, and a fourth test output unit 15C1 that are located outside the input waveguide 11A1.

The third GC 15B3 is connected to a first optical fiber in a three-core fiber array 5B, is also connected to the third test waveguide 15B2, and outputs, to the third test waveguide 15B2, third test light from the first optical fiber. The third GC 15B3 outputs, to the test monitor, third reflected light for the third test light from the third test waveguide 15B2. The third test output unit 15B1 of the third test waveguide 15B2 is connected to a third test input unit 25B1 of the first chip 3, also outputs the third test light from the third GC 15B3, and receives the third reflected light for the third test light from the third test input unit 25B1.

The fourth GC 15C3 is connected to a third optical fiber in the three-core fiber array 5B, is also connected to the fourth test waveguide 15C2, and outputs, to the fourth test waveguide 15C2, fourth test light from the third optical fiber. The fourth GC 15C3 outputs, to the test monitor, fourth reflected light for the fourth test light from the fourth test waveguide 15C2. The fourth test output unit 15C1 of the fourth test waveguide 15C2 is connected to a fourth test input unit 25C1 of the first chip 3, also outputs the fourth test light from the fourth GC 15C3, and receives the fourth reflected light for the fourth test light from the fourth test input unit 25C1.

The first chip 3 has the third test input unit 25B1, a third test waveguide 25B2, and a third loop mirror 25B3. The first chip 3 has a fourth test input unit 25C1, a fourth test waveguide 25C2, and a fourth loop mirror 25C3.

The third test waveguide 25B2 is a Si waveguide that is located outside the first input waveguide 23B1 serving as one end of the first chip 3, and connects the third test input unit 25B1 to the third loop mirror 25B3. The third loop mirror 25B3 receives the third test light from the third test waveguide 25B2, and reflects the third test light to the third test waveguide 25B2 as the third reflected light for the third test light.

The fourth test waveguide 25C2 is a Si waveguide that is located outside the input waveguide 23A1 serving as the other end of the first chip 3, and connects the fourth test input unit 25C1 to the fourth loop mirror 25C3. The fourth loop mirror 25C3 receives the fourth test light from the fourth test waveguide 25C2, and reflects the fourth test light to the fourth test waveguide 25C2 as the fourth reflected light for the fourth test light.

The third GC 15B3 is connected to the first optical fiber in the three-core fiber array 5B, and outputs, to the third test waveguide 15B2, the third test light from the first optical fiber. The third loop mirror 25B3 reflects the third test light from the third test waveguide 15B2 as the third reflected light to the third test waveguide 15B2. Subsequently, the test monitor connected to the third GC 15B3 receives the third reflected light from the third test waveguide 15B2. On the basis of the power of the third reflected light, the test monitor corrects the tilt of the first chip 3 while checking the alignment placement between the second optical waveguide 11 in the second chip 2 and the first optical waveguide 23 in the first chip 3.

The fourth GC 15C3 is connected to the third optical fiber in the three-core fiber array 5B, and outputs, to the fourth test waveguide 15C2, the fourth test light from the third optical fiber. The fourth loop mirror 25C3 reflects the fourth test light from the fourth test waveguide 15C2 as the fourth reflected light to the fourth test waveguide 15C2. Subsequently, the test monitor connected to the fourth GC 15C3 receives the fourth reflected light from the fourth test waveguide 15C2. On the basis of the power of the fourth reflected light, the test monitor corrects the tilt of the first chip 3 while checking the alignment placement between the second optical waveguide 11 in the second chip 2 and the first optical waveguide 23 in the first chip 3.

The optical integrated device 1E of the sixth embodiment implements alignment placement between the second optical waveguide 11 in the second chip 2 and the first optical waveguide 23 in the first chip 3 while correcting the tilt of the first chip 3 by using the two loop mirrors in the first chip 3. As a result, alignment placement between the optical modulator 12 and the PBC 24B and between the optical modulator 12 and the PR 24A can be implemented with high precision.

When the power of the third reflected light and the power of the fourth reflected light are both above a predetermined level, the test monitor can accurately determine that the second optical waveguide 11 in the second chip 2 and the first optical waveguide 23 in the first chip 3 are aligned.

For the sake of explanation, the case in which the third test waveguide 15B2 and the fourth test waveguide 15C2 are used to determine whether the second optical waveguide 11 and the first optical waveguide 23 are aligned using the test light of the two waveguides is illustrated as an example. However, the embodiment is not limited to the two waveguides, that is, two butt coupling points, and three or more waveguides may be used or a test waveguide, a GC, and a loop mirror may be located at each placement point and this can be modified as needed.

The optical waveguide is perpendicular to the second bonding surface 13A of the second chip 2 and the first bonding surface 3A of the first chip 3 at the butt coupling point between the second chip 2 and the first chip 3. As a result, reflected return light at the butt coupling point may return to the optical waveguide, and the reflected return light may destabilize light from a light source. In this regard, an embodiment that addresses such a situation is described below as a seventh embodiment.

### (g) Seventh Embodiment

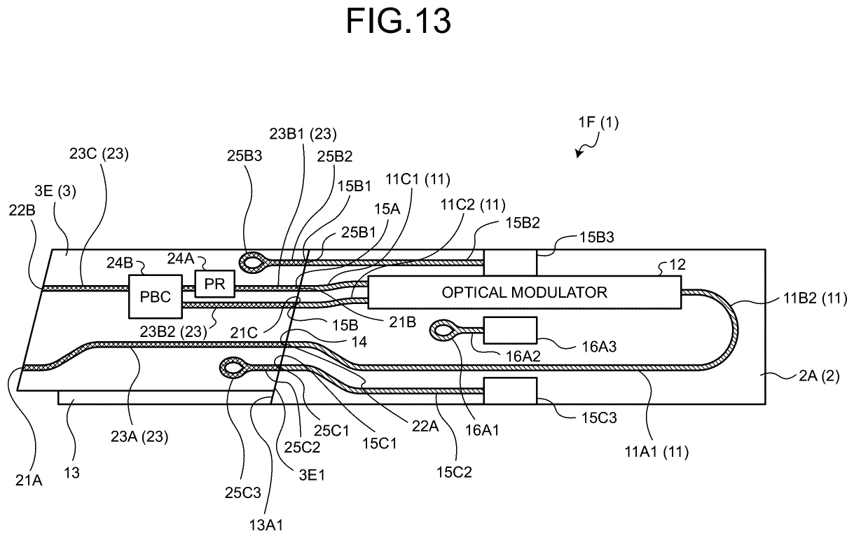

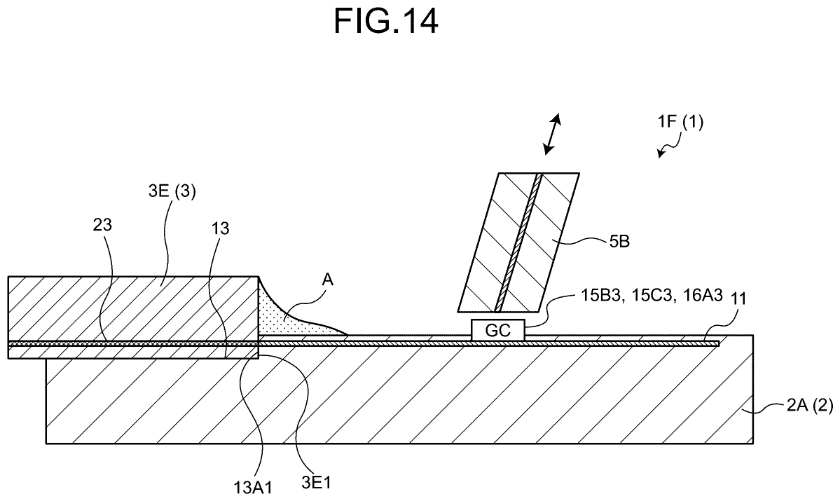

FIG. 13 is a planar schematic view illustrating an example of an optical integrated device 1F of the seventh embodiment, and FIG. 14 is a schematic cross-sectional view illustrating an example of the optical integrated device 1F. The same symbols are attached to the same configurations as those of the optical integrated device 1E in the sixth embodiment, and descriptions of duplicated configurations and operations are omitted. The difference between the optical integrated device 1F and the optical integrated device 1E is that a second bonding surface 13A1 of the trench 13 and a first bonding surface 3E1 of a first chip 3E are oblique to optical waveguides of a second chip 2A and the first chip 3E at a butt coupling point between the second chip 2A and the first chip 3E.

The planar shape of the first chip 3E is a parallelogram. The first chip 3E has a structure in which the first bonding surface 3E1 at the butt coupling point of the first chip 3E is oblique to the first optical waveguide 23.

The second chip 2A has a structure in which the wall surface of the trench 13, that is, the second bonding surface 13A1 at the butt coupling point of the second chip 2A is oblique to the second optical waveguide 11.

The second bonding surface 13A1 and the first bonding surface 3E1 at the butt coupling point where the input waveguide 23A of the first chip 3E is connected to the input waveguide 11A1 of the second chip 2A are obliquely in contact with the optical waveguide.

The second bonding surface 13A1 and the first bonding surface 3E1 at the butt coupling point where the first input waveguide 23B1 of the first chip 3E is connected to the first output waveguide 11C1 of the second chip 2A are obliquely in contact with the optical waveguide.

The second bonding surface 13A1 and the first bonding surface 3E1 at the butt coupling point where the second input waveguide 23B2 of the first chip 3E is connected to the second output waveguide 11C2 of the second chip 2A are obliquely in contact with the optical waveguide.

The second bonding surface 13A1 and the first bonding surface 3E1 at the butt coupling point where the third test waveguide 25B2 of the first chip 3E is connected to the third test waveguide 15B2 of the second chip 2A are obliquely in contact with the optical waveguide.

The second bonding surface 13A1 and the first bonding surface 3E1 at the butt coupling point where the fourth test waveguide 25C2 of the first chip 3E is connected to the fourth test waveguide 15C2 of the second chip 2A are obliquely in contact with the optical waveguide.

In the optical integrated device 1F of the seventh embodiment, the second bonding surface 13A1 and the first bonding surface 3E1 are oblique to the optical waveguides of the second chip 2A and the first chip 3E at the butt coupling point between the second chip 2A and the first chip 3E. As a result, reflected return light at the butt coupling point can be suppressed.

However, in the optical integrated device 1F of the seventh embodiment, since the planar shape of the first chip 3E is a parallelogram, when the first chip 3E is cut from a silicon wafer, the number of chips to be obtained may be reduced. In this regard, an embodiment that addresses such a situation is described below as an eighth embodiment.

### (h) Eighth Embodiment

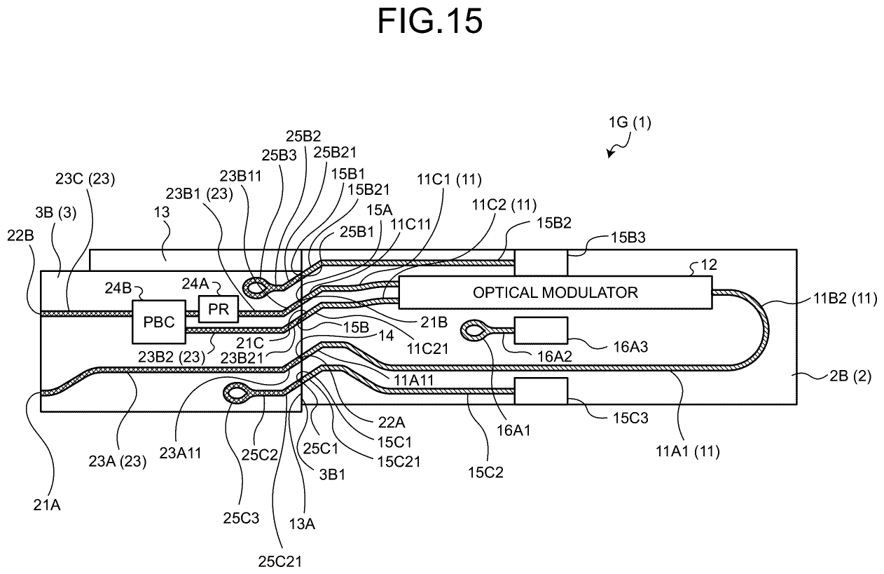

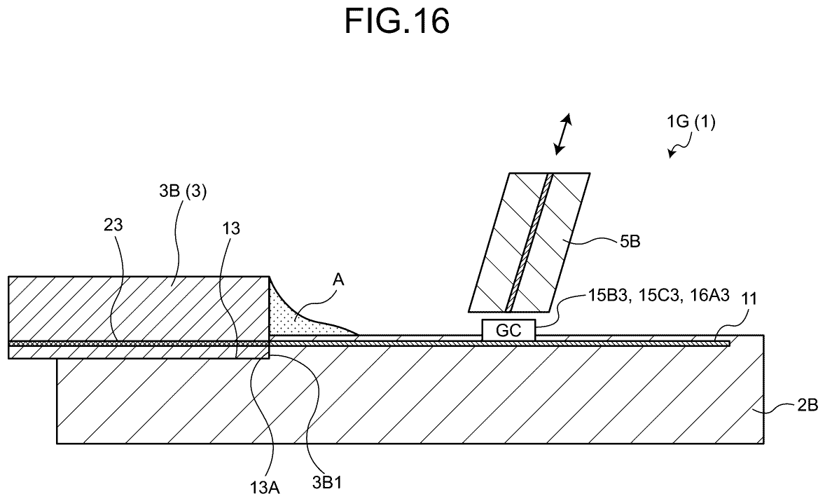

FIG. 15 is a schematic plan view illustrating an example of an optical integrated device 1G of the eighth embodiment, and FIG. 16 is a schematic cross-sectional view illustrating an example of the optical integrated device 1G. The same symbols are attached to the same configurations as those of the optical integrated device 1E in the sixth embodiment, and descriptions of duplicated configurations and operations are omitted. The difference between the optical integrated device 1G and the optical integrated device 1E is that a waveguide is located obliquely to the second bonding surface 13A of a second chip 2B and a first bonding surface 3B1 of a first chip 3B at a butt coupling point between the second chip 2B and the first chip 3B.

A waveguide near the first output unit 22A of the input waveguide 23A of the first chip 3B is set as an oblique waveguide 23A11. A waveguide near the input unit 14 of the input waveguide 11A1 of the second chip 2B is set as an oblique waveguide 11A11. Subsequently, the input waveguide 23A is optically connected to the input waveguide 11A1 by optical coupling of the oblique waveguides 23A11 and 11A11 by butt coupling.

A waveguide near the second input unit 21B of the first input waveguide 23B1 of the first chip 3B is set as an oblique waveguide 23B11. A waveguide near the first output unit 15A of the first output waveguide 11C1 of the second chip 2B is set as an oblique waveguide 11C11. The first output waveguide 11C1 is optically connected to the first input waveguide 23B1 by optical coupling of the oblique waveguides 23B11 and 11C11 by butt coupling.

A waveguide near the third input unit 21C of the second input waveguide 23B2 of the first chip 3B is set as an oblique waveguide 23B21. A waveguide near the second output unit 15B of the second output waveguide 11C2 of the second chip 2B is set as an oblique waveguide 11C21. The second output waveguide 11C2 is optically connected to the second input waveguide 23B2 by optical coupling of the oblique waveguides 23B21 and 11C21 by butt coupling.

A waveguide near the third test input unit 25B1 of the third test waveguide 25B2 of the first chip 3B is set as an oblique waveguide 25B21. A waveguide near the third test output unit 15B1 of the third test waveguide 15B2 of the second chip 2B is set as an oblique waveguide 15B21. The third test waveguide 15B2 is optically connected to the third test waveguide 25B2 by optical coupling of the oblique waveguides 25B21 and 15B21 by butt coupling.

A waveguide near the fourth test input unit 25C1 of the fourth test waveguide 25C2 of the first chip 3B is set as an oblique waveguide 25C21. A waveguide near the fourth test output unit 15C1 of the fourth test waveguide 15C2 of the second chip 2B is set as an oblique waveguide 15C21. The fourth test waveguide 15C2 is optically connected to the fourth test waveguide 25C2 by optical coupling of the oblique waveguides 25C21 and 15C21 by butt coupling.

In the optical integrated device 1G of the eighth embodiment, the oblique waveguides at the butt coupling point between the second chip 2B and the first chip 3B are optically coupled by butt coupling, thereby enabling suppression of reflected return light at the butt coupling point. In addition, since the planar shape of the first chip 3B is rectangular, when the first chip 3B is cut from a silicon wafer, the number of chips to be obtained can be increased compared to that of the first chip 3E in the seventh embodiment.

The optical integrated device 1G that suppresses reflected return light at the butt coupling point is not limited to the structure of the eighth embodiment, and another embodiment is described below as a ninth embodiment.

### (i) Ninth Embodiment

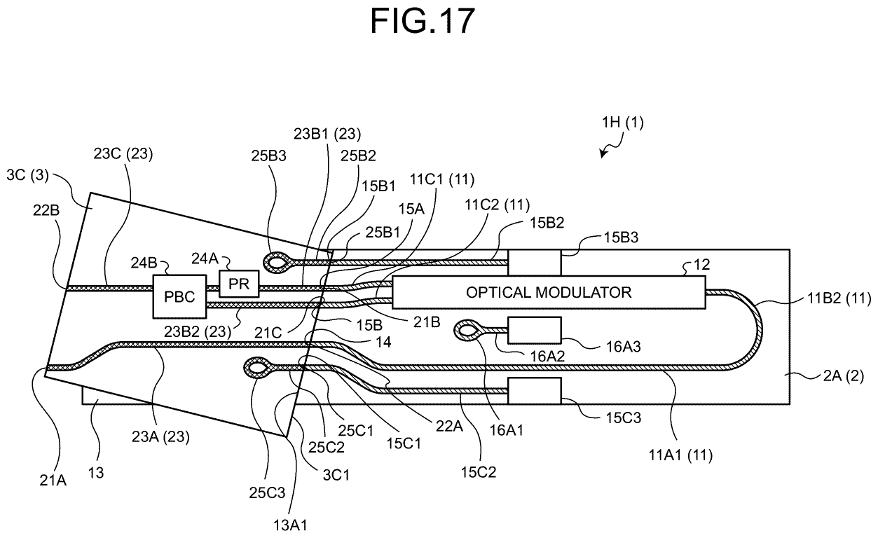

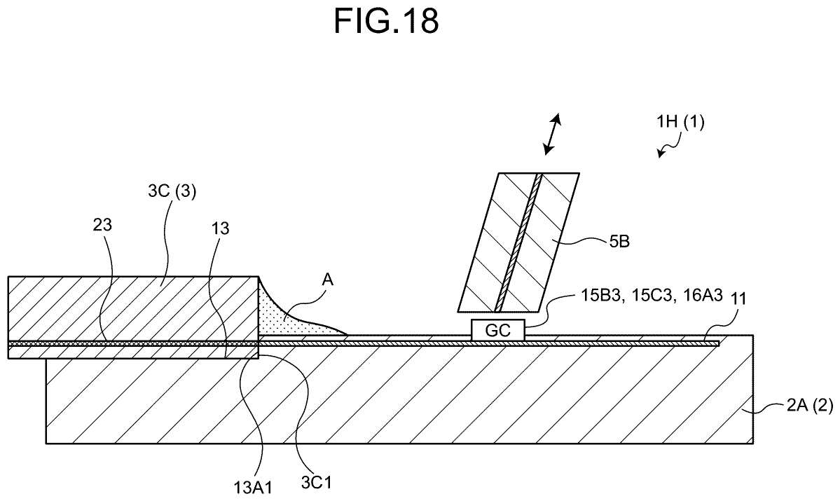

FIG. 17 is a planar schematic view illustrating an example of an optical integrated device 1H of the ninth embodiment, and FIG. 18 is a schematic cross-sectional view illustrating an example of the optical integrated device 1H. The same symbols are attached to the same configurations as those of the optical integrated device 1E in the sixth embodiment, and descriptions of duplicated configurations and operations are omitted. The difference between the optical integrated device 1H and the optical integrated device 1E is that the second bonding surface 13A1 of the second chip 2A and a first bonding surface 3C1 of a first chip 3C are oblique to the optical waveguides of the second chip 2A and the first chip 3C at a butt coupling point between the second chip 2A and the first chip 3C.

The second chip 2A has a structure in which the second bonding surface 13A1 of the trench 13, that is, a chip end face at the butt coupling point of the second chip 2A is oblique to the second optical waveguide 11.

The planar shape of the first chip 3C remains rectangular, but the first optical waveguide 23, the PR 24A, and the PBC 24B are located obliquely compared to those in FIG. 11, and the first bonding surface 3C1 at the butt coupling point of the first chip 3C is oblique to the first optical waveguide 23.

The second bonding surface 13A1 and the first bonding surface 3C1 at the butt coupling point where the input waveguide 23A of the first chip 3C is connected to the input waveguide 11A1 of the second chip 2A are obliquely in contact with the waveguide.

The second bonding surface 13A1 and the first bonding surface 3C1 at the butt coupling point where the first input waveguide 23B1 of the first chip 3C is connected to the first output waveguide 11C1 of the second chip 2A are obliquely in contact with the waveguide.

The second bonding surface 13A1 and the first bonding surface 3C1 at the butt coupling point where the second input waveguide 23B2 of the first chip 3C is connected to the second output waveguide 11C2 of the second chip 2A are obliquely in contact with the waveguide.

The second bonding surface 13A1 and the first bonding surface 3C1 at the butt coupling point where the third test waveguide 25B2 of the first chip 3C is connected to the third test waveguide 15B2 of the second chip 2A are obliquely in contact with the waveguide.

The second bonding surface 13A1 and the first bonding surface 3C1 at the butt coupling point where the fourth test waveguide 25C2 of the first chip 3C is connected to the fourth test waveguide 15C2 of the second chip 2A are obliquely in contact with the waveguide.

In the optical integrated device 1H of the ninth embodiment, the second bonding surface 13A1 and the first bonding surface 3C1 are oblique to the waveguides of the second chip 2A and the first chip 3C at the butt coupling point between the second chip 2A and the first chip 3C. As a result, reflected return light at the butt coupling point can be suppressed.

A form of connecting the optical fiber array 4 to the first chip 3C in the optical integrated device 1H of the ninth embodiment is described below as a tenth embodiment.

### (j) Tenth Embodiment

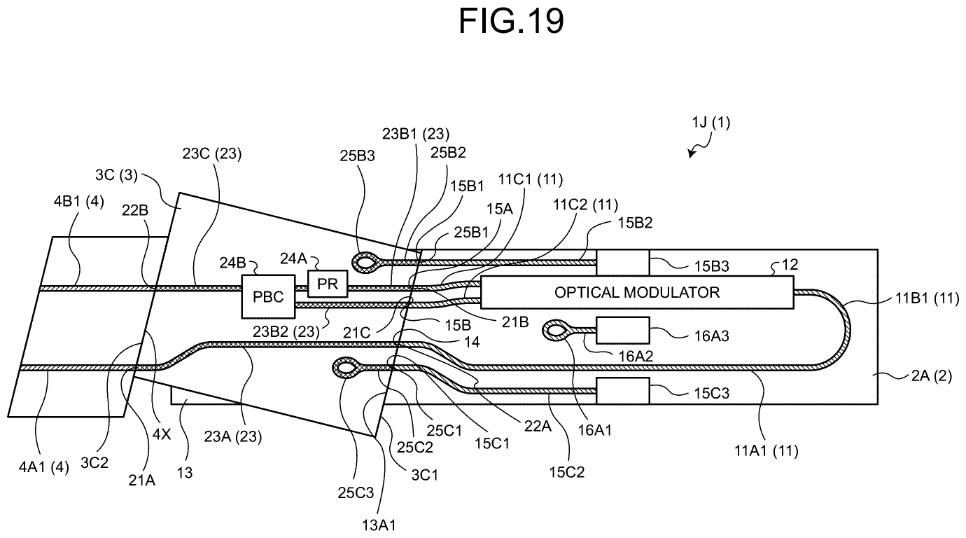

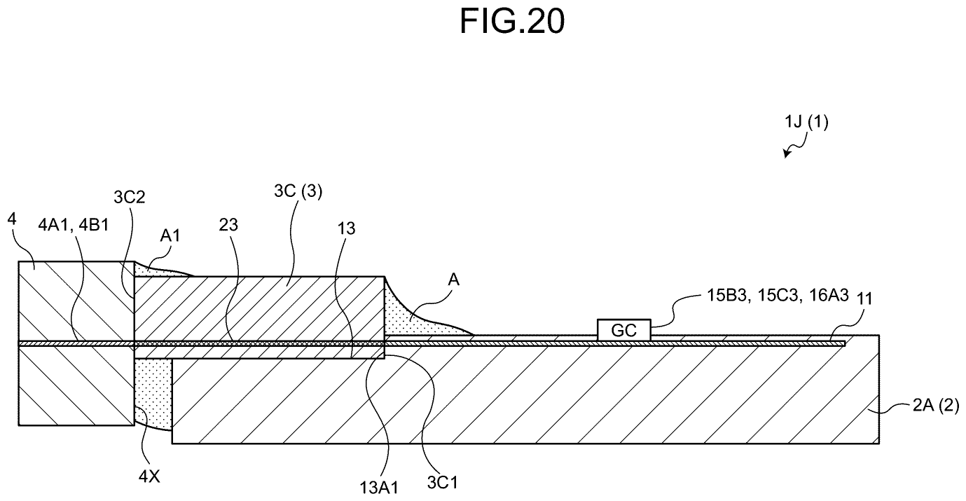

FIG. 19 is a schematic plan view illustrating an example of an optical integrated device 1J of the tenth embodiment, and FIG. 20 is a schematic cross-sectional view illustrating an example of the optical integrated device 1J. The same symbols are attached to the same configurations as those in the ninth embodiment, and descriptions of duplicated configurations and operations are omitted. The optical integrated device 1J illustrated in FIG. 19 has a configuration in which the first chip 3C in the optical integrated device 1H of the ninth embodiment is connected to the optical fiber array 4 with an optical adhesive A1 for alignment.

The first chip 3C is in contact with a fourth bonding surface 4X of the optical fiber array 4 at a third bonding surface 3C2 serving as a chip end face facing the first bonding surface 3C1 adjacent to the second chip 2A.

In the optical fiber array 4, the fourth bonding surface 4X adjacent to the third bonding surface 3C2 of the first chip 3C is oblique to the axial direction of the optical fiber array 4, so that an input-side optical fiber 4A1 and an output-side optical fiber 4B1 are located obliquely to the fourth bonding surface 4X of the optical fiber array 4.

The first chip 3C is aligned with the second chip 2A and fixed with an optical adhesive A. The input waveguide 23A of the third bonding surface 3C2 of the first chip 3C is optically connected to the input-side optical fiber 4A1 of the optical fiber array 4, and the output waveguide 23C of the third bonding surface 3C2 is optically connected to the output-side optical fiber 4B1 of the optical fiber array 4. Subsequently, the fourth bonding surface 4X of the optical fiber array 4 and the third bonding surface 3C2 of the first chip 3C are bonded with the adhesive A1. The optical integrated device 1J can be aligned with the optical fiber array 4.

In the optical integrated device 1J of the tenth embodiment, the case of alignment placement between the first chip 3C and the optical fiber array 4 is illustrated as an example. However, the optical fiber array 4 may be located at any angular position of the first chip 3C depending on the position of a driver of the optical modulator 12 and the shape of a package, and this can be modified as needed. In this regard, such an embodiment is described below as an eleventh embodiment.

### (k) Eleventh Embodiment

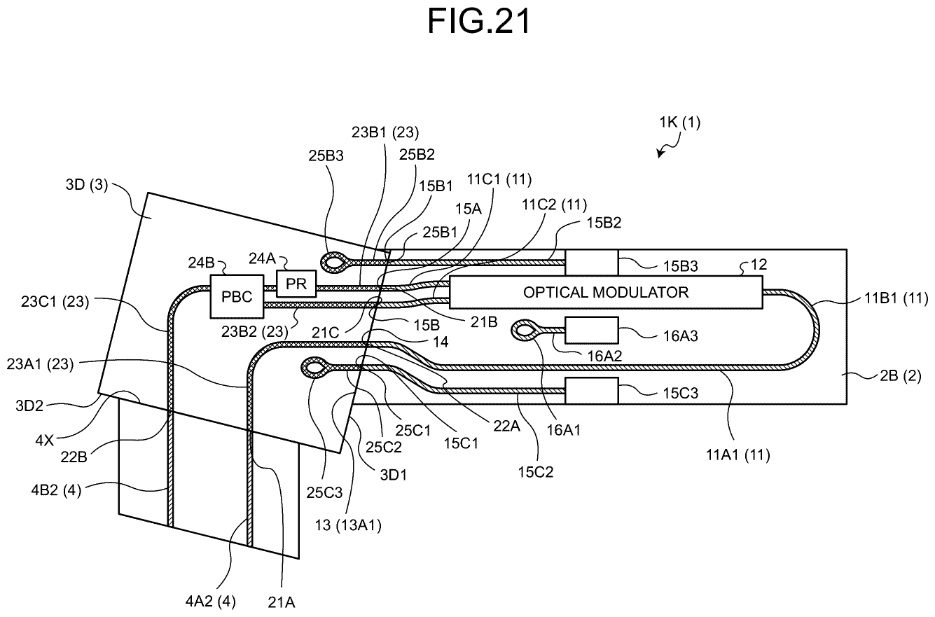

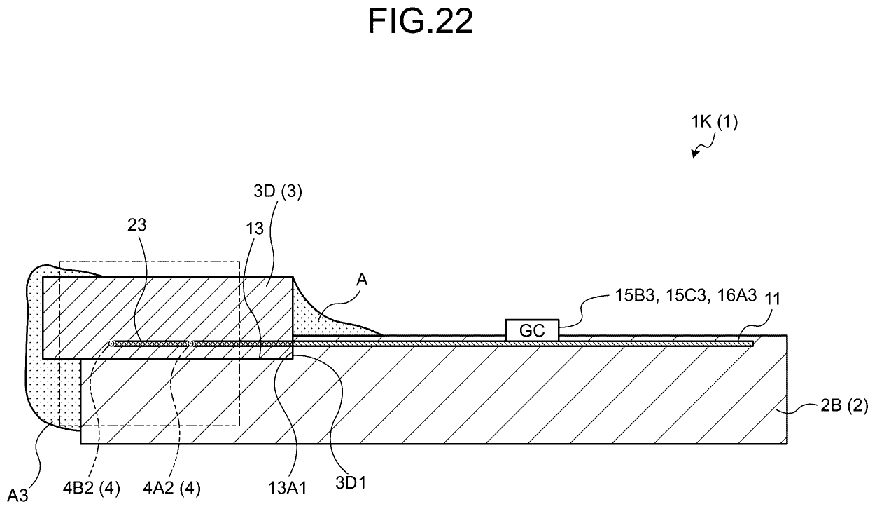

FIG. 21 is a planar schematic view illustrating an example of an optical integrated device 1K of the eleventh embodiment, and FIG. 22 is a schematic cross-sectional view illustrating an example of the optical integrated device 1K. The same symbols are attached to the same configurations as in the ninth embodiment, and descriptions of duplicated configurations and operations are omitted. The optical integrated device 1K illustrated in FIG. 21 has a configuration in which the optical fiber array 4 is connected with an optical adhesive A3 at an angular position of 90° to the axial direction of a first chip 3D in the optical integrated device 1H of the ninth embodiment.

The first chip 3D has a fifth bonding surface 3D2 that bonds an angular position of 90° to the axial direction of the first chip 3D, for example, a chip side orthogonal to a first bonding surface 3D1 bonded to the second chip 2B, to the optical fiber array 4. The first chip 3D has an output waveguide 23C1 and an input waveguide 23A1. The input waveguide 23A1 is a bent waveguide that bends from the fifth bonding surface 3D2 toward the first bonding surface 3D1. The output waveguide 23C1 is a bent waveguide that bends from the fifth bonding surface 3D2 toward the PBC 24B.

In the optical fiber array 4, the fourth bonding surface 4X bonded to the fifth bonding surface 3D2 of the first chip 3D is oblique to the axial direction of the optical fiber array 4. An input-side optical fiber 4A2 and an output-side optical fiber 4B2 are located obliquely to the fourth bonding surface 4X of the optical fiber array 4.

The first chip 3D is aligned with the second chip 2B and fixed with an optical adhesive A. The input waveguide 23A1 of the fifth bonding surface 3D2 of the first chip 3D is optically connected to the input-side optical fiber 4A2 of the optical fiber array 4, and the output waveguide 23C1 of the fifth bonding surface 3D2 is optically connected to the output-side optical fiber 4B2 of the optical fiber array 4. The fourth bonding surface 4X of the optical fiber array 4 is bonded to the fifth bonding surface 3D2 of the first chip 3D with an adhesive A3. In the optical integrated device 1K, the optical fiber array 4 can be located at an angular position of 90° to the axial direction of the optical integrated device 1K.

In the optical integrated device 1K of the eleventh embodiment, the optical fiber array 4 is located at an angular position of 90° to the axial direction of the optical integrated device 1K, which can contribute to miniaturization of the package.

The waveguides such as the second optical waveguide 11 and the first optical waveguide 23 may be, for example, rib waveguides, ridge waveguides, rectangular waveguides, or high-mesa waveguides. The rib waveguides are preferable because they are less susceptible to sidewall roughness in a core as light seeps through a slab portion as well, resulting in low-loss propagation. The rectangular waveguides are preferable because of their strong optical confinement, which reduces the loss even when a bending radius R is small. The waveguide may be a low-loss bent waveguide, which can be modified as needed.

The first optical waveguide 23 may be a PLC, an InP waveguide, or a GaAs waveguide with both a core and a cladding made of SiO₂. The core may be a Si waveguide with a core made of Si, a lower cladding made of SiO₂, and an upper cladding made of SiO₂, air, or SiN. When the waveguide is a Si waveguide, it is preferable because the light confinement is strong due to a large relative refractive index difference, thereby enabling a low-loss bent waveguide with a small bending radius R, that is, miniaturization of the optical device.

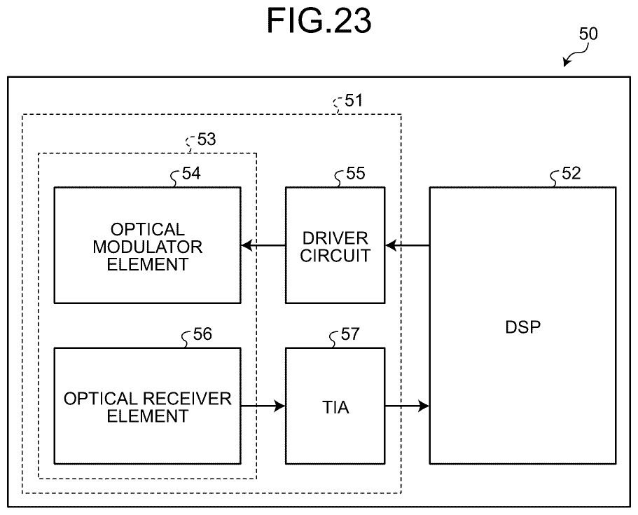

An optical transceiver 50 employing the optical integrated device 1 in the present example is described below. FIG. 23 is an explanation diagram illustrating an example of the optical transceiver 50 employing the optical integrated device 1. The optical transceiver 50 illustrated in FIG. 23 has an optical transmitter/receiver 51 and a digital signal processor (DSP) 52. The optical transmitter/receiver 51 has an optical modulator element 54, a driver circuit 55, an optical receiver element 56, and a transimpedance amplifier (TIA) 57. The DSP 52 controls the entire optical transmitter/receiver 51. The DSP 52 is an electrical component that performs digital signal processing of performing IQ modulation processing of transmission signals and demodulation processing of reception signals.

The DSP 52, for example, performs processing such as encoding of transmission data, generates an electrical signal including the transmission data, and outputs the generated electrical signal to the driver circuit 55. The driver circuit 55 drives the optical modulator element 54 in response to the electrical signal from the DSP 52. The optical modulator element 54 incorporates the optical integrated device 1 including an optical modulator that optically modulates signal light.

The optical receiver element 56 converts signal light into an electrical signal. The TIA 57 amplifies the electrical signal after electrical conversion and outputs the amplified electrical signal to the DSP 52. The DSP 52 obtains received data by performing processing such as decoding on the electrical signal acquired from the TIA 57.

For convenience of explanation, the case in which the optical transceiver 50 incorporates a communication element 53 including the optical modulator element 54 and the optical receiver element 56 is illustrated as an example; however, the optical transceiver 50 may also be an optical transmission device incorporating only the optical modulator element 54, and this can be modified as needed.

Each component of each unit illustrated in the drawings does not necessarily have to be physically configured as illustrated in the drawings. That is, the specific form of dispersion and integration of each unit is not limited to that illustrated in the drawings, but can be configured by functionally or physically dispersing and integrating all or part thereof in arbitrary units according to various loads and usage conditions.

Moreover, all or arbitrary some of various processing functions performed by each device may be performed on a central processing unit (CPU) (or a microcomputer such as a micro processing unit (MPU) and a micro controller unit (MCU)). It goes without saying that all or arbitrary some of the various processing functions may be performed on a computer program that is analyzed and executed by a CPU (or microcomputer such as an MPU or an MCU) or on hardware using wired logic.

According to one aspect, the workload needed for mounting can be reduced in chips including optical waveguides with electro-optic effects.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical integrated device comprising a first chip including an optical circuit, and a second chip including an optical waveguide including a material with an electro-optic effect larger than the electro-optic effect of a material of the first chip, wherein
the first chip is mounted in a trench formed on the second chip, and the first chip is optically coupled to the second chip by butt coupling.

2. The optical integrated device according to claim 1, wherein
the second chip includes
an optical modulator connected to the optical waveguide, and
the optical circuit includes
a polarization rotator that rotates a polarization of signal light from the optical modulator, and
a polarization multiplexer that polarization-multiplexes the signal light from the optical modulator and signal light after the polarization rotation performed by the polarization rotator.

3. The optical integrated device according to claim 1, wherein
the second chip includes
a second bonding surface, and
a second optical waveguide that is located obliquely to the second bonding surface,
the first chip includes
a first bonding surface that is in contact with the second bonding surface, and
a first optical waveguide that is located obliquely to the first bonding surface and is connected to the second optical waveguide.

4. The optical integrated device according to claim 1, wherein
the second chip includes
a second optical waveguide, and
a second bonding surface of the trench that is oblique to the second optical waveguide,
the first chip includes
a first optical waveguide connected to the second optical waveguide, and
a first bonding surface that is oblique to the first optical waveguide and is in contact with the second bonding surface.

5. The optical integrated device according to claim 1, wherein
the second chip includes
a second optical waveguide, and
a second oblique waveguide that is oblique to the second optical waveguide and is connected to the second optical waveguide,
the first chip includes
a first optical waveguide, and
a first oblique waveguide that is oblique to the first optical waveguide and is connected to the second oblique waveguide.

6. The optical integrated device according to claim 1, wherein the first chip is mounted face-down on the trench formed on the second chip.

7. The optical integrated device according to claim 1, wherein the second chip includes a thin-film LN (LiNbO₃) crystal material.

8. The optical integrated device according to claim 1, wherein a second optical waveguide in the second chip includes
a second input waveguide connected to the first chip,
a folded waveguide that is folded back between the second input waveguide and the optical modulator to connect the second input waveguide and the optical modulator, and
a second output waveguide connected to the optical modulator and to the first chip.

9. The optical integrated device according to claim 8, wherein the optical integrated device has a structure in which a diameter of the folded waveguide is longer than a spacing between the second input waveguide and the second output waveguide at a bonding portion where the first chip and the second chip are butt-coupled to each other.

10. The optical integrated device according to claim 8, wherein
a first optical waveguide in the first chip includes
a first input waveguide that connects an input-side optical fiber and the second input waveguide, and
a first output waveguide that connects an output-side optical fiber and the second output waveguide, and
the optical integrated device has a structure in which a spacing between the second input waveguide and the second output waveguide at a bonding portion where the first chip and the second chip are butt-coupled to each other is smaller than a spacing between the first input waveguide and the first output waveguide on a bonding surface between the input-side optical fiber and the output-side optical fiber.

11. The optical integrated device according to claim 8, wherein
the first chip includes
a reflective mirror,
the second chip includes
a third optical waveguide that is connected to the reflective mirror, and
a coupler that is connected to the third optical waveguide, and
when test light is input from the coupler to the third optical waveguide, the reflective mirror reflects reflected light for the input test light to the coupler.

12. The optical integrated device according to claim 11, wherein
the second chip includes
a fourth optical waveguide,
a first coupler that is connected to the fourth optical waveguide, and
a first reflective mirror that is connected to the fourth optical waveguide, and
when test light is input from the first coupler to the fourth optical waveguide, the first reflective mirror reflects reflected light for the input test light to the first coupler.

13. An optical transmission device comprising an optical modulator element that modulates light by using an electrical signal and transmits transmission light, wherein
the optical modulator element incorporates an optical integrated device including a first chip including an optical circuit, and a second chip including an optical waveguide including a material with an electro-optic effect larger than the electro-optic effect of a material of the first chip, the first chip is mounted in a trench formed on the second chip, and the first chip is optically coupled to the second chip by butt coupling.

14. An optical transceiver comprising an optical modulator element that optically modulates light by using a transmission signal and transmits transmission light, and an optical receiver element that receives a reception signal from received light by using light, wherein
the optical modulator element incorporates an optical integrated device including a first chip including an optical circuit, and a second chip including an optical waveguide including a material with an electro-optic effect larger than the electro-optic effect of a material of the first chip, the first chip is mounted in a trench formed on the second chip, and the first chip is optically coupled to the second chip by butt coupling.
